(19) United States
(12) Patent Application Publication
(10) Pub. No.: US 2003/0009443 A1
(43) Pub. Date: Jan. 9, 2003

(54) Generic data aggregation

(76) Inventor: Oleg Yatviskiy, Morganville, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/172,201

(22) Filed: Jun. 14, 2002

Related U.S. Application Data
(60) Provisional application No. 60/298,622, filed on Jun. 15, 2001.

(51) Int. Cl. G06F 7/00

(52) U.S. Cl. 707/1

(57) ABSTRACT

The invention describes a method, device and system for increasing the speed of processing data. The inventive method includes filtering the data, classifying the data, and generically applying logical functions to the data without data-specific instructions. Moreover, the steps of filtering, classifying and applying logical functions are based on a predetermined criteria. The inventive method further includes storing the data in an in-memory database.

### CROSS REFERENCE TO RELATED APPLICATIONS

This application claims priority under 35 U.S.C. §119(e) from provisional application No. 60/298,622 filed Jun. 15, 2001. The provisional application No. 60/298,622 is incorporated by reference herein, in its entirety, for all purposes.

### TECHNICAL FIELD

The invention relates generally to the processing of data, and more particularly to efficiently and generically aggregating data available on a communication network.

### BACKGROUND OF THE INVENTION

Recently, the collection and processing of data transmitted over communication networks, like the Internet, have moved to the forefront of business objectives. In fact, with the advent of the Internet, new revenue generating business models have been created to charge for the consumption of content received from a data network (i.e., content-based billing). For example, content distributors, application service providers (ASPs), Internet service providers (ISPs), and wireless Internet providers have realized new opportunities based on the value of the content that they deliver. As a result of this content-billing initiative, it has become increasingly important to intelligently collect and analyze content according to the business needs of the customer.

Unlike other data collection environments, communication networks like the Internet impose additional burdens on the collection and analysis process. For example, the Internet by its very nature is a network of unlimited data sources and correspondingly unlimited data types. As a result, the data collection and analysis process must be capable of understanding and processing the various types of data. Furthermore, the Internet communicates a vast quantity of data, only some of which may be needed to conduct the desired analysis. To simply store all of the data on the off chance that it may be used for subsequent processing would require a very large data store. Operating such a data store would result in undesirable processing time and wasted memory storage. Therefore, the data collection and analysis process must be capable of determining which of the data is desired, based on user criteria, and intelligently filter and classify the data (i.e., aggregate the data).

Currently, data aggregation is accomplished using various application specific (i.e., “non-generic”) methods. One method well known in the art, for example, performs aggregation by programming the appropriate filtering and classification techniques within the database operation itself. However, these “hard-coded” databases are limited to specific purposes only, for example, Web server databases. As a result, in the context of content collection and analysis, these “hard-coded” databases are too inflexible to efficiently satisfy the ever-changing face of a communication network like the Internet. For example, once the database is programmed to aggregate certain data, it must be re-programmed to accommodate the new data sources and corresponding new data items often introduced to the Internet.

These new data sources and new data items may provide information that is greatly desired by a particular organization or business group. Yet, because the required reprogramming necessary to collect and aggregate this new data is so time-consuming and labor-intensive, organizations often forego implementation and continue to use the stagnant “hard-coded” aggregation processes.

Therefore, there exists a need to provide a technique for allowing customers to create revenue models by recouping costs from network traffic, using scalable and flexible content analysis solutions. There also exists a need to provide a technique for aggregating data from a variety of different sources on the networks in a way that is capable of accommodating new data sources and new data types regularly added to such networks. The data aggregation process may be performed on data, both of which are stored on non-persistent memory (e.g., RAM).

### SUMMARY OF THE INVENTION

The invention describes a method, device and system for increasing the speed of processing data. The inventive method includes filtering the data, classifying the data, and generically applying logical functions to the data without data-specific instructions. Moreover, the steps of filtering, classifying and applying logical functions are based on a predetermined criteria. The inventive method further includes storing the data in an in-memory database. The step of classifying may include adjusting the classification of data as a function of the quantity of data classified, and/or compounding classification categories as a function of a logical relation between the categories. The inventive method further may comprise creating data control objects and storing the data control objects outside of the in-memory database, and using pointers to avoid redundant data. The method may create one or more records that describe a transaction.

The invention further provides a system for collecting and analyzing the transfer of content between two systems on a communication network. The system includes a content collection layer, a transaction layer, and a settlement layer. The content collection layer may include an input data adapter for converting raw data from one or more data sources to sets of relevant attributes. The content collection layer further may include a content data language component for creating new attributes, and a correlator component for grouping data. The content collection layer further may include an aggregator component for filtering and/or classifying the attributes. The transaction layer may include a content detail record database for storing the classified and filtered attributes. The transaction layer further may include a transaction component for capturing predetermined agreements regarding the value of the transferred content among users of the system. The settlement layer may include a rating component for providing a significance (e.g., a price) to the transaction, so as to provide a tangible value to the transaction.

### BRIEF DESCRIPTION OF THE DRAWINGS

Other features of the invention are further apparent from the following detailed description of the embodiments of the invention taken in conjunction with the accompanying drawings, of which:

FIG. 1 is a block diagram of a system for analyzing content transmitted over a communication network;

FIG. 2 is a block diagram further describing the components of the system described in FIG. 1;

FIGS. 3A and 3B provide a flow diagram further detailing the operation the system described in FIG. 1;

FIG. 4 provides a flow diagram detailing the population of data in an in-memory database;

FIG. 5 provides a flow diagram detailing a query mechanism for the in-memory database;

FIG. 6 is a flow diagram detailing a method of removing older entries from the in-memory database; and

FIG. 7 is a flow diagram detailing a method of removing data entries when the in-memory database exhausts its configured memory.

### DETAILED DESCRIPTION OF THE INVENTION

System Overview

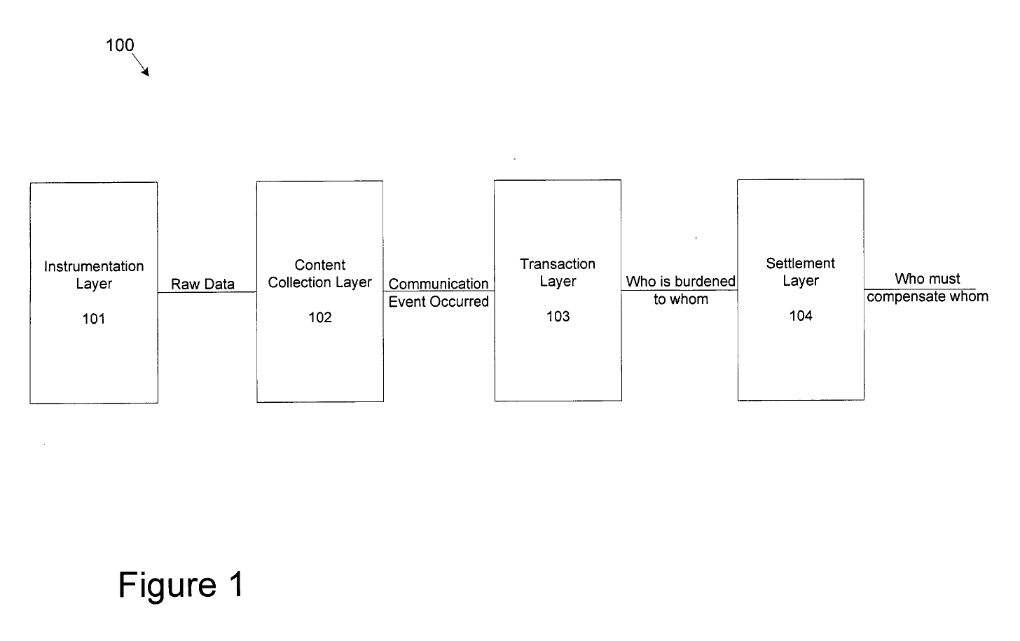

FIG. 1 is a block diagram of a system 100 for analyzing content transmitted over a communication network. Although the following description will be discussed in the context of collecting, processing and billing for data transmitted over the Internet, it should be appreciated that the invention is not so limited. In fact, the invention may be applied to any type of network, including a private local area network, for example. Also, the invention may be used for purposes other than billing for the usage of content. For example, the invention may be used to analyze the type of data transmitted over a particular network, or to determine the routing patterns of data on a network. Furthermore, the invention may be used to facilitate the intelligent collection and aggregation of data relevant to a particular industry. In addition, the invention may be used to track specific ip network resources and to detect fraud, for example.

In addition, it should be appreciated that the term “content” may be defined as data that is transmitted over the network. In the context of the Internet, content may include .mp3 files, hypertext markup language (html) pages, videoconferencing data, and streaming audio, for example. The terms “producer” and “customer” will be used throughout the description as well. Producer may refer to the primary creator or provider of the content, while customer is the primary recipient of the content. Both the producer and customer may be a human or a computer-based system.

As shown in FIG. 1, an instrumentation layer 101 provides raw data to a content collection layer 102. Instrumentation layer 101 may consist of various data sources, for example, network routers. The network routers may provide information regarding the various types of routed data, including for example, data format, originating Internet protocol (ip) address, and destination ip address. One example of such information is Cisco System's NetFlow™.

Content collection layer 102 collects information about the delivery of the content, as well as the substance of the content itself. Content collection layer 102 also may sort, filter, aggregate, and store the content according to the particular needs of the end user. In effect, content collection layer 102 is responsible for extracting meaningful information about ip traffic, and so it is provided with an understanding of the data sources in instrumentation layer 101. Content collection layer 102 also may transform the data from the plurality of sources in instrumentation layer 101 into standard formats for use in a transaction layer 103.

Content collection layer 102 is in communication with transaction layer 103. Generally, content collection layer 102 reports to transaction layer 103 that a relevant communication event has occurred and should be considered by the remainder of system 100. A communication event may be defined as any transfer of data between systems. Transaction layer 103 captures the predetermined agreements among the parties involved in system 100 regarding the value of the transferred content, as well as the value added by each of the individual parties in transferring such content. Therefore, transaction layer 103 is charged with understanding the nature of the parties, as well as the understanding the actions that one or more parties perform and the influence of such action on the respective parties.

Transaction layer 103 is in communication with a settlement layer 104. Settlement layer 104 captures the operations that are necessary to understand the significance of the transaction defined by transaction layer 103. For example, settlement layer 104 may rate a particular transaction by assigning a monetary value to the transaction. Settlement layer 104 also may divide the burdens and benefits of the monetary value among the relevant parties. In this way, settlement layer 104 ensures that certain parties receive a particular portion of the payment made by the other parties. Settlement layer 104 also may be responsible for delivering this burden and benefit information to the appropriate parties with the appropriate identifiers (e.g., account numbers).

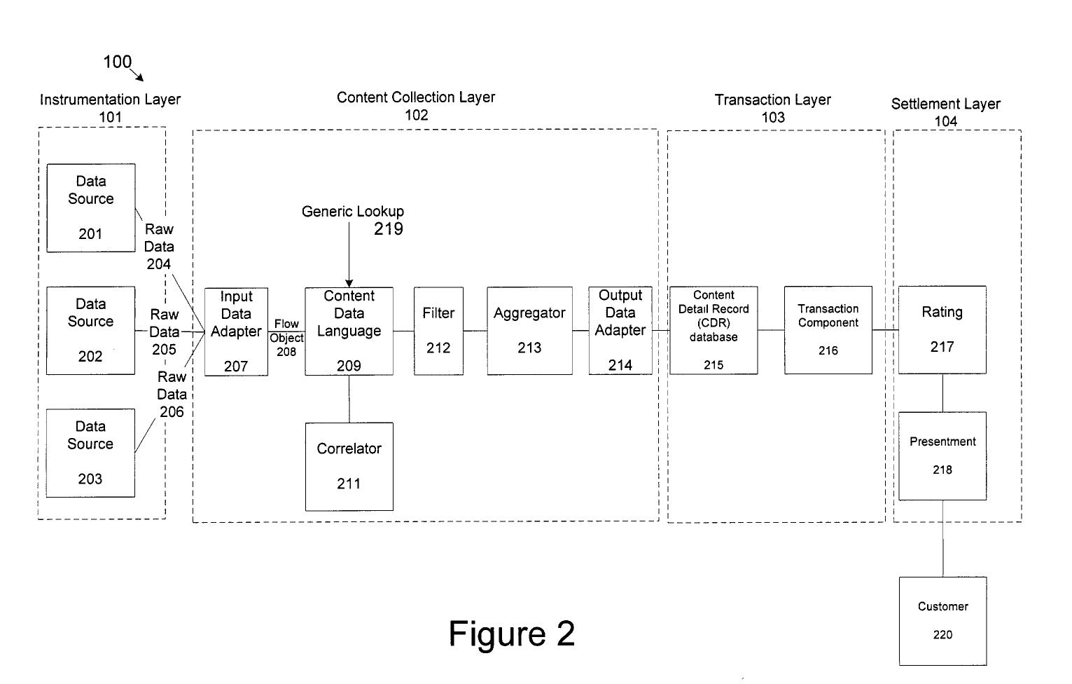

FIG. 2 is a block diagram further describing the components of system 100. As shown in FIG. 2, instrumentation layer 101 includes data sources 201-203 that each provides raw data 204-206, respectively, to collection layer 102. As discussed, data sources 201-203 may include various internetworking devices like routers, bridges, and network switches. Data sources 201-203 provide raw data 204-206 to an input data adapter 207. Accordingly, input data adapter 207 understands the operation of, and the data provided by, data sources 201-203. Although one input data adapter is shown in FIG. 2, it should be appreciated that more than one input data adapter may be used in system 100. For example, each data source may have a dedicated input data adapter.

Input data adapter 207 creates one or more flow objects 208 from raw data 204-206. Flow objects 208 are sets of attributes. The attributes may be any characteristics that are provided by, or can be derived from, raw data 204-206 provided by data sources 201-203, respectively. For example, flow objects 208 may include a set of attributes describing the source and destination, including source ip address, destination ip address, source interface, and destination interface. Because input data adapter 207 is charged with understanding raw data 204-206 from data sources 201-203, as well as the required flow objects 208 of system 100, it is capable of transforming the raw data into the flow objects, where the flow objects may be of a standard format.

Input data adapter 207 provides flow objects 208 to a content data language 209. Content data language 209 may transform the attributes in flow objects 208 into other attributes that are desired by a particular customer. For example, content data language 209 may derive a network identifier attribute that is not readily available from a data source, from a source address attribute and a destination address attribute that is provided by flow object 208 attributes from input data adapter 207. This derivation may be based on a customer's desire to determine which network conveyed the transaction between the source and the destination. Therefore, following this example, content data language 209 will know to extract the source address attribute and the destination address attribute from flow objects 208.

Content data language 209 may perform other functions as well. For example, content data language 209 may perform a generic lookup function 219 that is built into content data language 209. Generally, generic lookup 219 describes a technique for mapping any number of attributes to any number of other derived attributes. For example, generic lookup 219 may be used to map a unique resource locator (URL) attribute to a particular content-type attribute. Content data language 209 will be described in greater detail.

Content data language 209 also is in communication with a correlator 211. Generally, correlator 211 connects the many daily network content events from various network devices, like routers for example. Often, the connected data may come from distinctly different data sources at distinctly unrelated times. Correlator 211 allows this data to be intelligently connected to each other, regardless of how different the sources or of how disparate the time received. For example, a Netflow™ enabled router and a Radius™ enabled network access switch may each provide certain data that is relevant to one particular transaction. However, because portions of the data come from different devices, the data may arrive at system 100 at different times, and in different formats. Also, because each provides data that is necessary to complete one transaction, the data from each cannot be considered separately. Correlator 211 allows this data to be intelligently grouped regardless of the format of the data or of the time the data pieces are received.

Furthermore, correlator 209 may rearrange the order of the received flow objects 208 to suit the needs of the remainder of system 100. By performing such correlation without having to first store all of the data on a disk (e.g., a database), significantly faster processing is achieved. Correlator 209 may perform this correlation in real-time, for example.

Although system 100 has been described using content data language 209 and correlator 211, it should be appreciated that flow objects 208 may proceed directly to a filter 212, if no correlation is required and if no attribute derivation is required, for example. Filter 212 analyzes flow objects 208 to ensure that the provided attributes are desired by system 100. If flow objects 208 are not needed (i.e., a mismatch), filter 212 may prevent flow objects 208 from passing to an aggregator 213. Also, although filter 212 has been shown as a separate device in system 100, it should be appreciated that the functionality of filter 212 may be incorporated into aggregator 213.

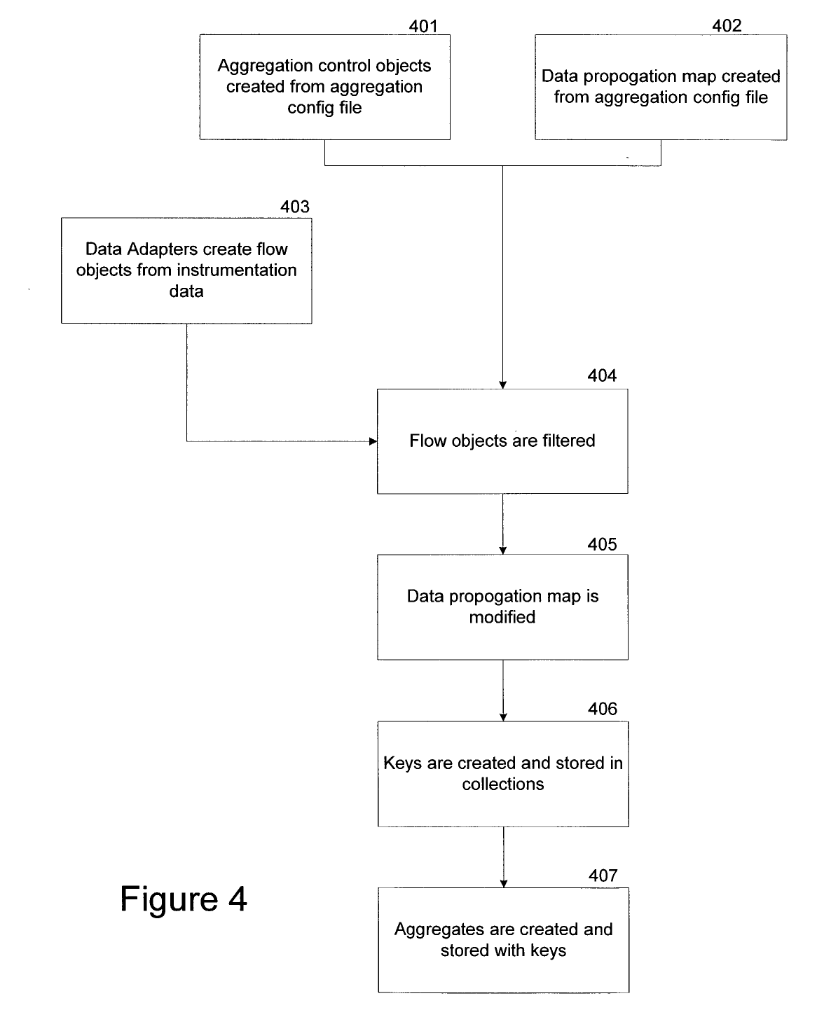

Filer 212 passes the matching flow objects to aggregator 213. Aggregator 213 may provide additional filtering and classification of the multitude of daily network content transactions, based on user criteria. Aggregator 213 may perform such filtering and classification in real-time. Aggregator 213 will be discussed in greater detail with reference to FIGS. 4-7. Aggregator 213 provides the filtered and classified information to an output data adapter 214. Output data adapter 214 may convert the data from aggregator 213 into one or more content detail records (CDR) for storage in a content data record (CDR) database 215. Therefore, CDR database 215 stores a description of a content event.

CDR database 215 passes a content data record (CDR) onto a transaction component 216. Transaction component 216 captures the predetermined agreements among the parties involved in system 100 regarding the value of the transferred content, as well as the value added by each of the individual parties in transferring such content. Therefore, transaction component 216 understands the nature of the parties and the actions that one or more parties perform, and the influence of such action on the respective parties.

Transaction component 216 provides the transaction information to a rating component 217. Rating component 217 provides a weight or significance (e.g., a price) to the transaction, so as to provide a tangible value to the transaction. Rating component 217 may make this determination based on various metrics including the type of the content, the quantity of content consumed, the place and time that the content is delivered, or the quality of the content, for example. Therefore, rating component 217 allows system 100 to provide some contextual value, indicting the significance or relevance that certain content or information has to the individual customer.

Rating component 217 provides the rated transaction to a presentment component 218. Presentment component 218 may provide the capability for a customer 220 to view their real-time billing information, for example, over the network. Presentment component 218 also may attach relevant identifiers to the bill (e.g., account numbers, etc.).

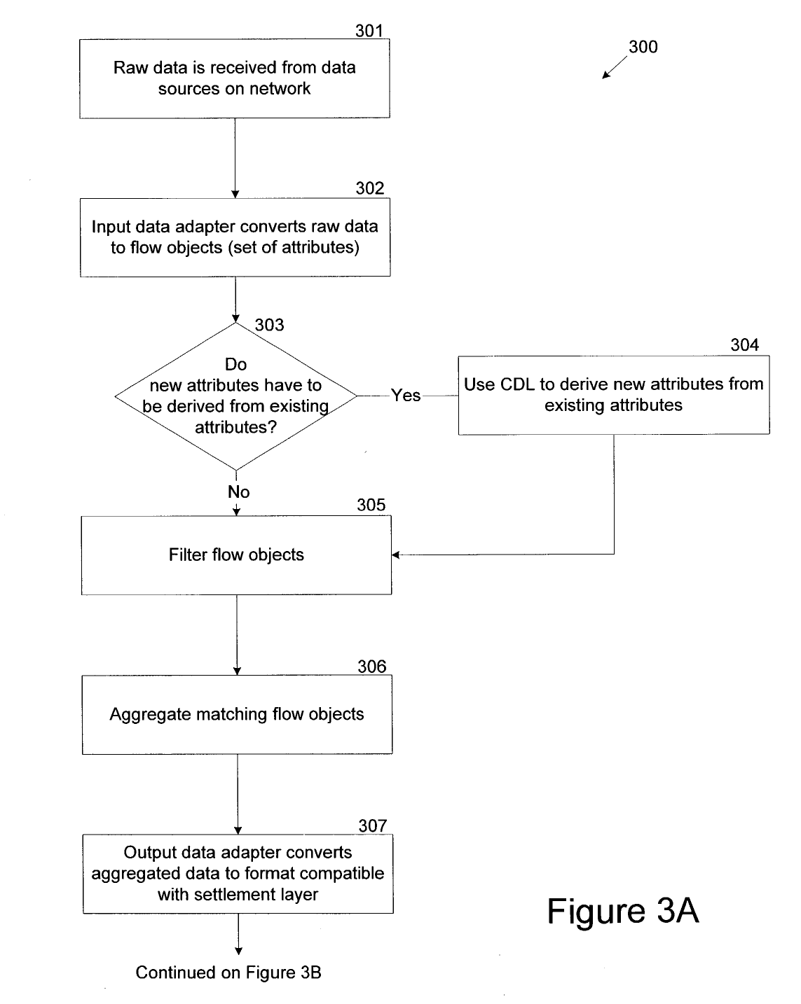

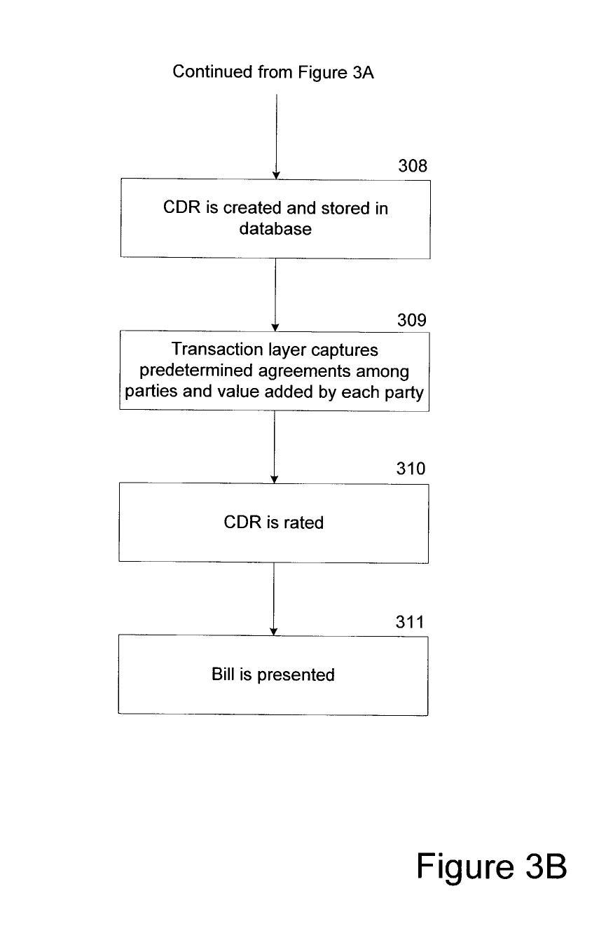

FIGS. 3A and 3B provide a flow diagram further detailing the operation 300 of system 100. As shown in FIG. 3A, in step 301, raw data 204-206 is received from data sources 201-203. In step 302, input data adapter 207 converts raw data 204-206 to flow objects 208, where flow objects 208 are sets of attributes, determined from raw data 204-206. In step 303, it is determined whether there is a need to derive new attributes from the existing attributes found in flow objects 208. If there is such a need, in step 304, CDL 209 is used to derive new attributes from existing attributes. Also, as discussed above, attributes may be correlated by correlator 211.

In step 305, flow objects 208 are filtered by filter 212. In step 306, the matching flow objects (i.e., those passed by filter 212 ) are further filtered and classified by aggregator 213 (as discussed more fully with reference to FIGS. 4-7). In step 307, output data adapter 214 converts the data aggregated by aggregator 213 to a format compatible with transaction layer 103.

As shown in FIG. 3B, in step 308, output adapter 214 may format the aggregated data into one or more content data records for storage in CDR database 215. In step 309, transaction component 216 captures the predetermined agreements among all the parties and the value added by each of the individual parties. In step 310, the CDR is rated based on predetermined metrics (e.g., time of transmission and quality of content). In step 311, a bill is presented to the customer.

Generic Aggregation

Aggregation is the process of filtering, classifying, and applying logical or mathematical function to data, based on user criteria. The aggregation process may be accomplished both as the data is received in real-time and offline. The aggregation process may create one or more records that provide information sufficient to adequately describe a transaction or event. As discussed with reference to FIG. 2, the result of aggregation may be one or more Content Detail Records.

Aggregation Terminology

Aggregation may apply to any of the “attributes” of the data. As discussed with reference to FIG. 2, data sources 201-203 deliver raw data 204-206 to input data adapter 207. Input data adapter 207 converts raw data 204-206 into flow object 208. Flow object 208 is an abstraction used to represent a set of attributes. The attributes, therefore, represent data that has been manipulated by input data adapter 207 to be understood by the remaining components of the system. The attributes also reflect those characteristics of the data that are desired by the user. For example, in the context of the Internet, attributes may include source ip address, destination ip address, source interface, and destination interface. Although aggregator 213 is shown as a component of system 100, it should be appreciated that the aggregator may be accomplished by a list of computer-readable instructions (e.g., an aggregation file) located on anywhere within the system. Aggregator 213 is located in the block of FIG. 2 to facilitate the discussion of the operation of the system.

Attributes may be defined by a name or label that identifies the attribute, a unique identifier number that distinguishes one attribute from another, and/or a designation that identifies a type of attribute. For example, one particular attribute may have a label “CONTENT_TYPE,” a unique identifier of “8,” and a type called “STRING” that identifies the attribute as a series of alphanumeric characters. The following is just one example of possible attributes:

TABLE 1

| | | |
|---|---|---|
| DOMAIN | 1 | APO_TYPE_STRING |
| HIT_BYTES | 2 | APO_TYPE_LONG_LONG |
| MISS_BYTES | 3 | APO_TYPE_LONG_LONG |
| TIME_STAMP | 4 | APO_TYPE_LONG |
| BYTES | 5 | APO_TYPE_LONG_LONG |
| URL | 6 | APO_TYPE_STRING |
| DOMAIN | 7 | APO_TYPE_STRING |
| CONTENT_TYPE | 8 | APO_TYPE_STRING |
| HIT_FLAG | 9 | APO_TYPE_STRING |
| URL_EXTENSION | 10 | APO_TYPE_STRING |
| CONTENT_PROTOCOL | 11 | APO_TYPE_STRING |

Notably, because attributes that are string type values may consume larger portions of memory, a single copy of each string value may exist in the database. If the same string is needed in other locations in the database, a pointer to the single copy may be used, instead of storing an additional copy of the string.

The classification portion of the aggregation process may be based on one or more “keys.” As is well known to those skilled in the art, a key corresponds to one or more categories in a database table that participates in unique identification of each row of the table. Every attribute that has a key may be represented by an object which is called the “data key” object. For example, if the source address attribute is a key for a particular aggregation, a corresponding data key will be created for this object that contains the object data.

An aggregation that has multiple attributes as keys may be represented in memory as a collection of “data keys,” where every data key corresponds to a distinct value of the first key attribute. Every data key in that collection, points to the collection of data keys that keep the values for the second key attribute. In turn, every element of the second collection points to the collection of data keys that keep the values for the third key attribute, and so on. If a data key contains the value for the key that does not have any subkeys, this data key will be constructed without any pointers to collections. In the case where several aggregations are configured, common keys may be shared among the aggregations.

Aggregating the data may be based on a set of key attributes and/or a set of counter attributes. Counter attributes are those attributes that are used to contain the current state of an aggregation. For a given set of keys, counters may be aggregated. The counter attributes may be the same as, or different than, the key attributes. For example, the “destination address” key attribute may be used both as a key and as a counter. In the latter case, function such as LAST_SEEN_VALUE can be applied to a destination address, so that every time aggregation data is output, only the last seen value of destination address is output. Alternatively, “destination address” may be used as an aggregation key, while “cache hit bytes” may be used as a counter. In this instance, when the destination address appears in the cache the counter is updated (i.e., incremented or decremented).

The following is an example of an aggregation configuration file that helps further define the terms used in the aggregation process of the invention:

TABLE 2

<Aggregation>
AGGREGATION_NAME CacheCustomer
AGGREGATE_BY_TIME_INTERVAL yes
#SUMMARIZE no
<Keys>
<Attribute>
ATTRIBUTE_NAME NCP_ACCOUNT_NO
ALIAS_NAME CustomerAccount
</Attribute>
</Keys>
<Counters>
<Attribute>
ATTRIBUTE_NAME HIT_BYTES
ALIAS_NAME HitBytes
AGGR_FUNCTION_NAME SUM
</Attribute>
</Counters>
</Aggregation>

The “<Aggregation>” indicates that what follows is an aggregation. The “AGGREGATION_NAME” specifies the name or label for the particular aggregation. In the above example, the Aggregation name is “CacheCustomer.” If aggregation is to be output to CDR database 215, the aggregation name should coincide with the database table name into which aggregation will be written. The “AGGREGATE_BY_TIME_INTERVAL” is a yes/no flag that indicates whether the aggregated data should be grouped by certain time intervals. In the above example, the “yes” indicates that the aggregation will be grouped by a time interval. The “SUMMARIZE” is a yes/no flag that determines whether aggregation will be summarized after it is filtered and categorized. In the above example, the flag is set to “no,” indicating that the data will be sent directly to output data adapter 214, after the filtering and characterizing logic have been applied.

The “<Keys>” denotes the beginning of the section that describes the attributes that serve as keys to the aggregation. The “<Attribute>” denotes the beginning of the aggregation attribute description. The “ATTRIBUTE_NAME” is the name or label of the attribute, as described with reference to Table 1. In the above example, the “ATTRIBUTE_NAME” is “NCP_ACCOUNT_NO.” The “ALIAS_NAME” is the alternative name of the attribute. The “ALIAS_NAME” must coincide with the column name of CDR database 215 table into which the values of the particular attribute are to be written. In the above example, the “ALIAS_NAME” is defined as “CustomerAccount.” The “</Attribute>” denotes the end of the aggregation attribute description.

As discussed above, certain attributes may be used as counters to keep track of certain operations. The “<Counters>” denotes the beginning of the descriptions of those attributes that serve as counters. Therefore, in the example above, the attribute known as “HitBytes” will serve as the first counter. Also, “AGGR—FUNCTION—NAME” is the name of the function to invoke on an existing “HitByte” data value and a new “HitByte” data value when new data is submitted to the aggregation. In the above example, “SUM” indicates that the existing and new “HitByte” values will be added. The “</Counter>” denotes the end of the descriptions of those attributes that serve as counters, and the “</Aggregation>” indicates the end of the “CacheCustomer” aggregation.

In sum, the aggregation file above represents an aggregation called “CacheCustomer” that aggregates over a predetermined time interval without summarizing the aggregated data. The aggregation is a function of a key that is based on the “CustomerAccount” attribute alone. Therefore, the aggregation will classify the data based on a customer account indicator. For the “CustomerAccount” key, the addition of the existing and new “HitBytes” attributes will serve as a counter. Using this counter, the customer associated with a customer account will be able to determine the value provided by the cache device installed by the service provider. In this example, every cache hit means that browser request was satisfied very quickly, and thus served its purpose. The number of bytes served after the cache hit is a further measurement of service of a cache device rendered to a given customer.

In addition, it should be appreciated that more than one aggregation may be run simultaneously, but with different parameters. For example, the single aggregation process shown in Table 2 may be conducted over two overlapping intervals (e.g., over 5 and over 10 minutes). Also, two or more aggregations may be run simultaneously where, for example, the same aggregation receives data from two distinct data adapters.

Aggregation “buckets” are storage points that contain the counters associated with a particular key. Therefore, for example, if the key that contains destination address, source address and hit byte only uses hit byte as the counter, there will be an aggregation bucket for the hit byte counter. Also, in order to avoid duplicating data for identical keys, counters for each aggregation are stored in distinct aggregation buckets, under the same key.

An aggregation thread is an instance of the aggregation. The following is an example of an aggregation thread:

Thread CacheCustomer

Filter AccFilter

Adapter LogFileAdapter 1

Aggregation CacheCustomer

Period 1

NonRealTimeInterval 1

DataSetPath C:\temp

FileRetain 10

The “Filter” parameter in the aggregation thread specifies that the generic filter with the specified name “AccFilter” must be matched in order for the data to be aggregated. The “Filter” parameter may include multiple names. In this case, the designated multiple names must match in order for the data to be aggregated. The “Adapter” parameter in the aggregation thread definition identifies that Data Adapter “LogFileAdapter1” is the adapter that submits data to this aggregation thread. The “Period” parameter identifies how often (e.g., in minutes) the aggregation thread will output a file. The “NonRealTimelnterval” specifies time interval (e.g., in minutes) over which data needs to be summarized. The “DataSetPath” specifies the top directory under which will be created the file hierarchy for the aggregation files of the aggregation thread. The “FileRetain” parameter specifies maximum number of files to keep in the output directory for the aggregation thread.

Aggregation Process and Data Structure

The process of aggregating data may include factors such as which data is to be collected and which is to be deleted, how the data is to be classified and/or filtered, and how often the data should be aggregated (e.g., real-time, monthly, etc.). Aggregation also may include performing certain operations on the counter attributes, including summing, determining a minimum or maximum, and determining a number of counter updates. In addition, and depending upon the desires of the customer, aggregation may involve a number of other functions including applying filters to delete undesired data and to pass desired data to transaction layer 103 (as described with reference to filter 212 in FIG. 2).

As used throughout, the term “in-memory” database refers to the non-permanent memory portion of the database. This non-permanent memory typically is smaller in size, but faster in processing speed than permanent memory. An example of such in-memory may be dynamic random access memory (DRAM) or static random access memory (SRAM).

Because the aggregation of data is accomplished within the non-permanent memory (i.e., in-memory database), certain considerations are necessary to ensure efficiency and speed. First, the invention uses an “adoptive collection” process. It is well known in the art that certain large collections of data are more suited to a hierarchical scheme (e.g., a binary tree). It is similarly well known in the art that smaller collections of data are more suited to a simpler scheme (e.g., arrays or lists). In fact, the large data collections cannot be updated efficiently if the data collection is implemented as an array, and updating smaller collections implemented as a binary tree often is an inefficient use of memory resources. The invention, therefore, adapts the scheme to the complexity of the collected data. For example, the invention may first employ a simple array collection scheme for certain data. Once the complexity of the collection reaches a certain threshold (e.g., four elements), however, the invention automatically may adopt a more optimal collection representation, such as binary tree. Therefore, the invention is able to adapt to a complicated hierarchical collection scheme. This “adoptive collection” can be performed in real-time as the data is received. This is a significant advantage over hard-coded collection schemes that must be re-written in order to accommodate increased or decreased complexity and load of certain collections.

The invention also benefits from the use of pointers in the key structure that serve to save memory space. As discussed, aggregation that has multiple attributes as keys may be represented in memory as a collection of “data keys,” the data key corresponds to a distinct value of the first key attribute. The data key in a collection points to the collection of data keys that keep the values for the second key attribute. In turn, each element of the second collection points to the collection of data keys that keep the values for the third key attribute, and so on. Therefore, the use of these pointers saves memory space. Moreover, if a particular data key contains a value for a key that does not have any subkeys, this data key will be constructed without any pointers to collections. In the case where several aggregations are configured, common keys may be shared among the aggregations.

Pointers also may be used for redundant attribute strings. Certain attributes with long string values may consume a great deal of memory. Therefore, the invention may have just one copy of every string value in the database. When an attribute with the same string value needs to be stored in the database, a pointer to the original string is stored instead of the copy, thus conserving additional memory.

When several aggregations are configured, certain key attributes may be shared such that multiple data keys do not need to be constructed for the same attribute value. This structure permits certain data keys to point to two or more collections of values of other key attributes.

The invention also conserves memory space by modifying particular objects based on the way that the object's associated data resides in the database. These modifications may be made based on predetermined data structure decisions made during implementation. By creating objects that are streamlined to their associated data, memory space is further conserved. Therefore, the objects are generic without sacrificing memory space.

One example of such object modification relates to pointers. Virtual table pointers are well known in the art. When a virtual function is created in an object, the object must keep track of the function. A virtual function table is kept for each type of object, and each object keeps a virtual table pointer, which points to the virtual function table. This allows the object to appear the same, but act differently. However, it is well known by those skilled in the art, that virtual table pointers require a great deal of overhead memory.

The invention avoids the unnecessary use of such overhead memory by using control objects, instead of requiring the data objects stored in the in-memory database to have virtual functions and corresponding virtual table pointers. The data control objects are created from the configuration, and determine such aspects as: which objects to create, when the objects are to be created, how data is to be extracted from the objects, and how the objects should eventually be destroyed, whether the object is a key or a counter (or both), how many bytes long the object should be, and/or how the object gets updated.

For example, consider the source address, destination address, and hit byte keys. During configuration each key has a data control object created for it. Therefore, each object has information regarding how it should behave. This intelligence is stored in the control objects and outside of the in-memory database. However, the data (located in the in-memory database) corresponding to the object does not contain this intelligence, and thus reduces the required in-memory space. Therefore, the data control objects result in a memory savings for each data object stored in the in-memory database.

Another way that an object may be modified so as to conserve memory space is by using different objects to represent certain types of data keys. For example, as described above, data buckets are used to contain the counters associated with a particular key. The objects may be optimized such that a data key that is not a counter has no intelligence necessary to understand even that buckets exist. Using the previous example, where source address is used as a key but not a counter, the source address control object may not store a pointer to a bucket, nor will it have any intelligence associated with counters or buckets. Therefore, the key-only object may be somewhat different, and perhaps less complex, than the counter-based object. In this way, the particular object is optimized so as to not waste memory space by pointing to buckets (or even having knowledge of buckets) that are nonexistent.

It should be appreciated that this memory saving tactic can be extended to structures other than data buckets. For example, the invention similarly may conserve memory for keys that do not have subcollections. In this instance, the object for they key, may have no intelligence related to the existence or manipulation associated with subcollections.

Each aggregation bucket may have multiple counters. The invention's flexibility of using multiple buckets for the same key instead of multiple keys, each having its own aggregation bucket may provide more efficient use of memory. For example, where one aggregation is configured to occur every five minutes, and another aggregation using the same counter is configured to occur every ten minutes, the counters for the aggregations may be stored under the same key in two different aggregation buckets. This eliminates the need for creating two different keys with the same data.

The invention conserves the space in the non-persistent in-memory database using a “compound keying” technique. Compound keying describes the notion of intelligently grouping certain keys based on some logical relation between the keys. As discussed with the “adoptive collection” technique, certain smaller collections of data may be configured to be collected in arrays. However, in cases where the arrays hold more elements than are required, even the arrays represent wasted memory space. For example, a key with only one or two data elements will not efficiently be accommodated by a four-element array. Therefore, where a key is known to have less elements than the designated array, compound keys may serve to conserve valuable memory space.

For example, when aggregating source address and Quality of Service (QoS), a customer may determine that there will be just one QoS value for each source address key. Therefore, during configuration, the source address key and QoS key can be combined into a compound key, where each key is referred to as a “compound key part.” The single compound key data structure contains both source address and QoS. Having a single compound key instead of a key and subkey permits faster access to the QoS element, because there is no need to conduct a search of a subcollection to get the element. When additional flow objects arrive at the aggregation, the aggregation validates that the QoS is the same and the counter is updated. Compound keys are particularly useful where the customer knows in advance that a certain key will only have a certain number of data elements, less than the number of elements established for the array.

The compound keying used in the invention is to be distinguished from similar compound keying performed with hard-coded grouping instructions, because hard-coded grouping results in a loss of generality that is maintained with the invention. This is because the predetermination made by the invention is accomplished during the configuration by setting up the compound keying capability, for example, without having to specify those attributes that require compound keying. The required attributes are then added after the configuration, for example through a graphical user interface. The hard-coded computer instructions, on the other hand, must expressly identify the attributes. Any subsequent changes render the hard-coded instructions useless or at least less efficient.

Aggregation Process Features

The following description describes three features of the aggregation process with respect to the operation of the in-memory database: database population, query support, and garbage collection. It should be appreciated, however, that these features are not exclusive, but are meant to further describe the efficiency and speed of the aggregation process on the database operation.

FIG. 4 provides a flow diagram detailing the population of data in the in-memory database. As is well known to those skilled in the art, database population involves the storing of data objects in the database. As shown in FIG. 4, in step 401 input data adapter 207 creates flow objects 208 from data provided by data sources 201-203 in instrumentation layer 101 and, data control objects are created from the aggregation configuration file. The invention stores data objects in an in-memory database. Navigation through the in-memory database is controlled by data control objects that are created from the configuration.

As discussed, these data control objects may be used instead of relying on virtual table points within the data objects, so as to conserve memory space. The data control objects determine which data objects to create, when the data objects should be created, how to extract data from the objects, and how to delete the objects, for example. Also, class inheritance may be used in in-memory database population. Class inheritance describes the ability to extend a class definition by declaring a new class that inherits characteristics from the old class. Class inheritance may be used for the data objects to extend base classes for keys, data buckets, and data bucket intervals.

In step 402 data propagation maps also are created from the aggregation configuration file. As discussed above, filtering may be used prior to aggregating the data. In step 403, input data adapter 207 creates flow objects 208 from raw data 204-206 provided by data sources 201-203. In step 404, filter 212 is applied to flow objects 208. In order to provide efficient support for filter 212, data propagation maps may be used. In step 405, the data propagation map is modified depending on whether there was a match or mismatch with filter 212. Based upon the match or mismatch, the data propagation map instructs which of the collections and subcollections should be searched and which should be updated. More specifically, when a filter associated with a first aggregation returns a mismatch, the mismatched flow objects should not be used in the subsequent aggregation. In this case, the propagation map is updated to indicate that changes need not be propagated to this collection. Therefore, if another aggregation whose filter passed the flow objects (or another aggregation without any filtering) uses the same keys as the first aggregation, those keys still need to be searched. However, keys specific to the aggregation that did not match a filter need not be searched and updated. In order to facilitate this search-saving step (which in turn permits faster processing), every aggregation thread initially registers itself in the data propagation map.

In one example, a first aggregation may use keys Source Address and Interface Number, and a second aggregation may use keys Source Address and Destination Address. Assuming the keys are not compound keys (as discussed above), typical data population flow requires that a key with a matching source address is first found for a value of provided flow object source address attribute. Once this occurs, the counters are updated in the subkeys associated with the provided interface number and destination address. If the first aggregation's filter causes a mismatch, it updates the data propagation map to decrement the number of subscriptions to the Interface Number key (e.g., it goes to 0) and to the Source Address key (e.g., it goes to 1). Based on this mapping, the second aggregation will continue to look for matching source addresses in the Source Address collection, and update the key's counters for the provided destination address. However, because the number of subscriptions on Interface Number has been decremented (e.g., to 0), this collection will not be unnecessarily searched and updated.

The propagation map also permits differentiation between the propagation subscription and the update subscription. Using the above example, if the second aggregation uses keys Source Address, Interface Number, and Quality of Service, the Interface Number key may continue to have subscription for propagation, because the Interface Number must be considered to update the second aggregation. However, the Interface Number key would not have a subscription for updating, because the mismatched flow objects cannot update the first aggregation.

Returning to FIG. 4, if a collection that needs to be propagated or updated does not have key value specified in the flow objects, a new key is constructed and added to a collection in step 406. If the collection needs to be updated, it is updated based on the values of the counter attributes provided by the flow objects in step 407.

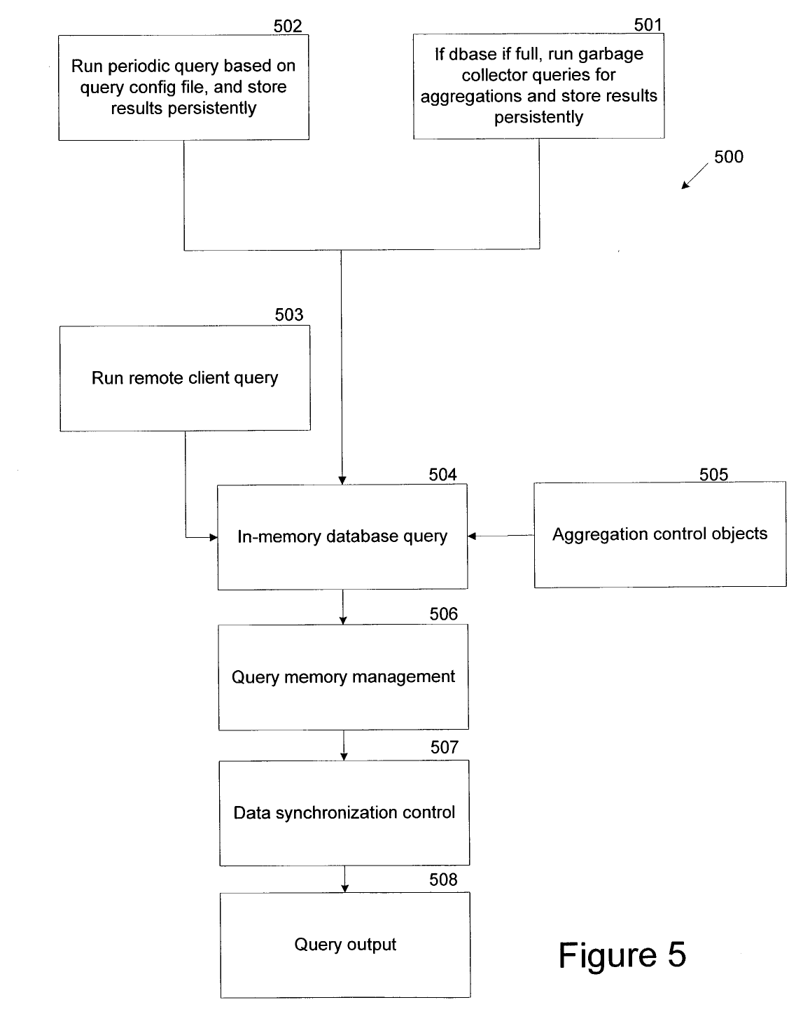

FIG. 5 provides a flow diagram detailing in-memory database query mechanism 500. As shown in FIG. 5, three distinct types of database queries may get triggered: garbage collector query, remote client query, and periodic aggregation query. It should be appreciated that other types of queries, not shown in FIG. 5, also may be conducted.

In step 501, if in-memory database is full, garbage collector queries for the results of the ongoing aggregations, and the results are stored persistently in certain query files. Step 501 is conducted on aggregations that are configured to periodically output data to the query files. In step 502, periodic queries are run for one or more aggregations, based on the query configuration file. The results of this query may be stored persistently in a separate file for every aggregation instance in order to maintain sufficient distinction from other aggregation instances. In step 503, a remote client query may be conducted. Because of bandwidth concerns, remote client queries may be conducted incrementally on part of in-memory database's table (e.g., N rows at a time). In this case, the aggregation process must track the completion status of the query, for example, until the query is completed or until the remote client terminates the query request. It should be appreciated that partial querying and corresponding completion status similarly may be conducted for other database query types.

In step 504, the in-memory database query is conducted in accordance with aggregation control objects (from step 505 ) that were created based on the aggregation configuration. In step 506, the query memory management ensures that every query has its own pool of memory to operate. There is also a maximum amount of memory that queries can use to store their intermediate results. If all the memory from query's own pool is used, or maximum amount of memory for query use is used, queries that need more memory get suspended until other queries release some of the memory they currently use. In step 507, data synchronization control guarantees data integrity through placing locks on the data collections that are read to prevent data inconsistency because of ongoing inserts, deletes, and updates, and also ensures that any output file can be associated with a specific range of input data submitted to the system. The latter is a necessary provision for fault-tolerant implementation. In step 508, the query is outputted.

Because the invention accomplishes aggregation in non-permanent memory (i.e., in-memory database), data must be efficiently moved to permanent memory (i.e., “garbage collection”).

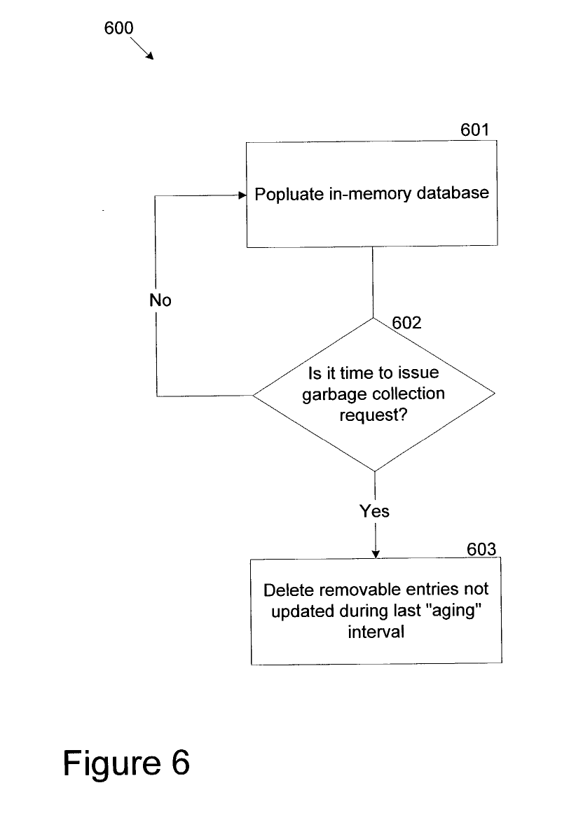

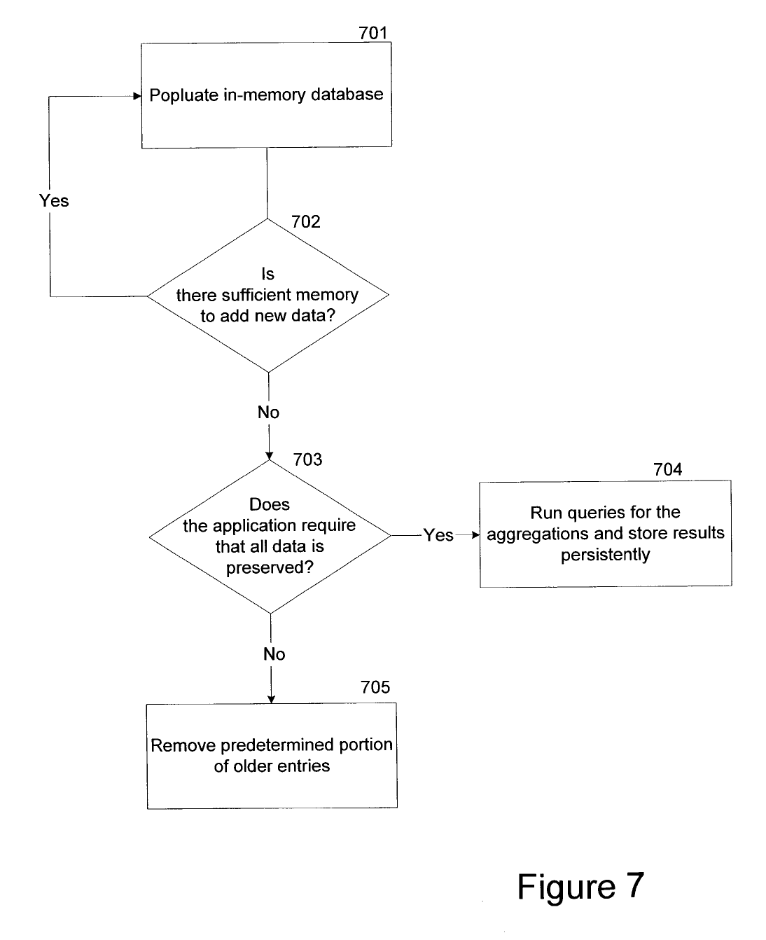

FIGS. 6 and 7 provide flow diagram describing two methods of conducting garbage collection. As is well known to those skilled in the art, garbage collection describes the process by which dynamically allocated storage is reclaimed during the execution of a program. Automatic garbage collection is usually triggered during memory allocation when an amount of free memory falls below some predetermined threshold, or after a certain predetermined number of allocations. Typically, normal execution of the program is suspended and the garbage collector is run. FIG. 6 is a flow diagram detailing method of periodic garbage collection and FIG. 7 is a flow diagram detailing garbage collection when the database is full. However, it should be appreciated that other methods of garbage collection, well known to those skilled in the art, also may be accomplished.

FIG. 6 is a flow diagram detailing periodic garbage collection. Periodic garbage collection ensures that “stale” data records will be removed periodically from in-memory database. As shown in FIG. 6, in step 601 in-memory database is populated with data. In step 602, it is determined whether the predetermined period to begin garbage collection has expired. The predetermined period may represent any quantity of time.

If the predetermined time has not expired, in-memory database continues to be populated with data in step 601 unless in-memory database is full. If the latter is the case, new data is discarded. If, on the other hand, the predetermined period has expired, removable entries that were not updated, or at least traversed, during the last garbage collection cycle are deleted from the in-memory database in step 603. The removable entries may include data objects and corresponding keys and data buckets, for example. This method may be desired when garbage collection is queried remotely. In this instance, this garbage collection method ensures that client who queries the database more often than the periodic interval will receive data that entered the database before it became full.

FIG. 7 is a flow diagram detailing garbage collection when in-memory database is full. As shown in FIG. 7, in step 701, in-memory database is populated with data. In step 702, it is determined whether there is sufficient memory in in-memory database to add new data. If it is determined that there is sufficient memory in in-memory database to add new data, the database continues to be populated with data. If, on the other hand, in-memory database does not have sufficient memory to add new data, in step 703 it is determined whether the particular application requires that the aggregated data must be accounted. If the application requires that all of the data be preserved, queries are run for all the ongoing aggregations and the results of the queries are stored persistently, in step 704. In either case, no less than a predetermined portion (e.g., at least twenty percent) of older entries may be removed in step 705. This method is desired when aggregations output data periodically to the local files.

Also, although these garbage collection techniques are described based on certain conditions (e.g., periodic intervals or amount of available memory space), it should be appreciated that the invention includes other garbage collection techniques that may be accomplished sporadically and unrelated to any preset conditions.

The invention is directed to a system and method for aggregating data. The invention often was described above in the context of the Internet, but is not so limited to the Internet, regardless of any specific description in the drawing or examples set forth herein. For example, the invention may be applied to wireless networks, as well as non-traditional networks like Voice-over-IP-based networks and/or private networks. It will be understood that the invention is not limited to the use of any of the particular components or devices herein. Indeed, this invention can be used in any application that requires aggregating data. Further, the system disclosed in the invention can be used with the method of the invention or a variety of other applications.

While the invention has been particularly shown and described with reference to the embodiments thereof, it will be understood by those skilled in the art that the invention is not limited to the embodiments specifically disclosed herein. Those skilled in the art will appreciate that various changes and adaptations of the invention may be made in the form and details of these embodiments without departing from the true spirit and scope of the invention as defined by the following claims.

What is claimed is:

1. A method of increasing the speed of processing data, comprising:
filtering the data;
classifying the data;
generically applying logical functions to the data without data-specific instructions, wherein the filtering, classifying and applying logical functions are based on a predetermined criteria; and
storing the data in an in-memory database.

2. The method of claim 1, wherein the classifying comprises adjusting the classification of data as a function of the quantity of data classified.

3. The method of claim 1, further comprising creating data control objects and storing the data control objects outside of the in-memory database.

4. The method of claim 1, wherein the classifying the data comprises compound classification categories as a function of a logical relation between the categories.

5. The method of claim 1, further comprising the using pointers for redundant data.

6. The method of claim 1, further comprising the creating one or more records that describe a transaction.

7. The method of claim 1, wherein the filtering comprises determining whether the data is substantially equivalent to a predetermined criteria.

8. The method of claim 1, further comprising correlating the data.

9. The method of claim 8, wherein the correlating comprises collating data received at different times.

10. The method of claim 8, wherein the correlating comprises collating data received in different formats

11. The method of claim 8, wherein the correlating comprises rearranging data received as a function of predetermined criteria.

12. The method of claim 1, wherein the filtering, classifying and applying logical functions are accomplished in real-time as the data is received.

13. The method of claim 1, further comprising providing the data to an output adapter.

14. The method of claim 1, wherein the received data is a flow object.

15. The method of claim 1, further comprising receiving the data from an input data adapter.

16. The method of claim 1, further comprising deriving new data attributes from existing data attributes using a content data language.

17. The method of claim 1, further comprising applying mathematical function to the data.

18. The method of claim 1, further comprising creating one or more records describing a transaction.

19. The method of claim 1, wherein in the data comprises attributes.

20. The method of claim 1, wherein the filtering, classifying and generically applying logical functions are a function of one or more keys.

21. The method of claim 20, wherein the keys include at least one of the following: subkeys, compound keys, and data keys.

22. The method of claim 1, further comprising adoptively collecting data as a function of the complexity of the data.

23. The method of claim 1, wherein the adoptively collecting of data includes at least one of the following: an array collection scheme and a binary tree collection scheme.

24. The method of claim 1, further comprising providing pointers.

25. The method of claim 1, further comprising providing control objects.

26. The method of claim 25, wherein the control objects determine at least one of the following: objects to create, when the objects are created, data extracted from the objects, object destruction, data length of object, and updating of object.

27. A device for increasing the speed of processing data, comprising:
a processor for filtering, classifying and generically applying logical functions to the data without data-specific instructions, wherein the filtering, classifying and applying logical functions are based on a predetermined criteria; and
an in-memory database for storing the processed data.

28. The device of claim 27, wherein the data comprises attributes.

29. The device of claim 27, wherein the attributes comprises counters, wherein the counters identify a present state of the data.

30. The device of claim 29, wherein the filtering, classifying and generically applying logical functions to the data are a function of the counters.

31. The device of claim 27, wherein the attributes comprises keys.

32. The device of claim 31, wherein the keys correspond to one or more categories in a database table.

33. The device of claim 31, wherein the keys may be represented by a data key object.

34. The device of claim 31, wherein the filtering, classifying and generically applying logical functions to the data are a function of the keys.

35. The device of claim 27, further comprising buckets that store counters associated with a particular key.

36. A system for collecting and analyzing the transfer of content between two systems on a communication network, comprising:
a content collection layer;
a transaction layer; and
a settlement layer

37. The system of claim 36, wherein the content collection layer comprises an input data adapter for converting raw data from one or more data sources to sets of relevant attributes.

38. The system of claim 36, wherein the content collection layer comprises a content data language component for creating new data, and a correlator component for grouping the data.

39. The system of claim 36, wherein the content collection layer comprises an aggregator component for classifying the data.

40. The system of claim 36, wherein the transaction layer comprises a content detail record database for storing the data.

41. The system of claim 36, wherein the transaction layer comprises a transaction component for capturing predetermined agreements regarding the value of the transferred content among users of the system.

42. The system of claim 36, wherein the settlement layer comprises a rating component for providing a significance to the transaction.

43. A computer-readable medium having computer-executable instructions, comprising:
filtering the data;
classifying the data;
generically applying logical functions to the data without data-specific instructions, wherein the filtering, classifying and applying logical functions are based on a predetermined criteria; and
storing the data in an in-memory database.

44. The computer-readable medium of claim 43 having further computer-executable instructions comprising creating data control objects and storing the data control objects outside of the in-memory database.

45. The computer-readable medium of claim 43 having further computer-executable instructions comprising using pointers for redundant data.

46. The computer-readable medium of claim 43 having further computer-executable instructions comprising creating one or more records that describe a transaction.

47. The computer-readable medium of claim 43 having further computer-executable instructions comprising correlating the data.

48. The computer-readable medium of claim 43 having further computer-executable instructions comprising deriving new data attributes from existing data attributes using a content data language.

49. The computer-readable medium of claim 43 having further computer-executable instructions comprising applying mathematical function to the data.

50. The computer-readable medium of claim 43 having further computer-executable instructions comprising adoptively collecting data as a function of the complexity of the data.
